(19) United States
(12) Patent Application Publication
(10) Pub. No.: US 2018/0272251 A1
(43) Pub. Date: Sep. 27, 2018

(54) Wastesolution Treatment Systems

(71) Applicant: EnSolve Biosystems, Inc., Raleigh, NC (US)

(72) Inventors: Richard L. Penny, Hampstead, NC (US); Jason A. Caplan, Raleigh, NC (US); Marika Suominen-Yeh, Raleigh, NC (US)

(73) Assignee: EnSolve Biosystems, Inc., Raleigh, NC (US)

(21) Appl. No.: 15/991,027

(22) Filed: May 29, 2018

Related U.S. Application Data
(63) Continuation-in-part of application No. 13/650,259, filed on Oct. 12, 2012, now Pat. No. 9,993,745.
(60) Provisional application No. 61/627,489, filed on Oct. 13, 2011.

(51) Int. Cl. B01D 17/04; B01D 17/00

(52) U.S. Cl. CPC B01D 17/047; B01D 17/10

(57) ABSTRACT

Wastesolution treatment systems and methods are provided which may remove particulates and hydrocarbons from wastesolution. Embodiments may be used to treat scrubber wastesolution from exhaust gas cleaning (“EGC”) systems. Some embodiments may be used with terrestrial EGC systems and others may be used for maritime ship EGC systems. Certain embodiments remove free phase oil and particulates from the wastesolution. Some embodiments may utilize a biogenerator cultured with hydrocarbon degrading microorganisms to reduce the concentration of oils in the water. Certain embodiments may utilize a clarifier and filtration unit to remove contaminants in the water. The wastesolution may be recirculated through the system until the measured contaminant concentration drops below a threshold value. The treated wastesolution may be stored, reused, or may be safely discharged from the system.

### CROSS-REFERENCES TO RELATED APPLICATIONS

This application is a Continuation-In-Part of U.S. application Ser. No. 13/650,259 filed Oct. 12, 2012, and claims the benefit of U.S. Provisional Application No. 61/627,489 filed on Oct. 13, 2011, the contents of each application are herein incorporated by reference in their entirety.

### BACKGROUND

Wet scrubber systems help reduce the amount of pollutants from exhaust gas streams by capturing and absorbing pollutants in a scrubbing liquid. Pollutants may include particulates such as dust particles or soot. Further, pollutants may include gaseous pollutants such as sulfur dioxide. In a wet scrubber system, the scrubbing liquid may be specifically configured to remove particular pollutants from the gas stream. In order for the scrubbing liquid to capture and absorb pollutants from the gas stream, the scrubbing liquid must contact the pollutants. In some systems, the scrubbing liquid contacts the pollutants in the gas stream by being sprayed into the gas stream. Other systems may force the gas stream through a pool of the scrubbing liquid. The scrubbing liquid may then reduce the pollutants in the gas stream. Thereafter, the treated gas stream may be released from the system with reduced adverse effects on the environment. Accordingly, wet scrubber systems are important devices which help minimize the amount of pollutants that are released into the air from various gas streams.

Although wet scrubber systems help reduce the amount of particulates and gaseous pollutants released into the air, a substantial amount of polluted scrubber wastesolution may be produced in such systems. The scrubber wastesolution from wet scrubber systems contains the pollutants which were removed from the gas stream and may pose a potential environmental risk if released untreated. The inventors of the present application have developed an efficient and effective way of reducing the concentration of pollutants from the wastesolution of wet scrubber systems. In addition, other solutions may be treated in a similar manner. The treated solution(s) may then be released into the environment with minimal adverse impact to the environment.

### SUMMARY

Certain embodiments of the present invention generally relate to systems and methods of treating solutions, including aqueous solutions. Embodiments of the present invention may be particularly advantageous for treating scrubber wastesolutions produced, for example, in a wet scrubbing process wherein a scrubbing solution is utilized to wash materials, such as pollutants, from a gas stream. The resulting scrubber wastesolution comprises the initial scrubbing solution and materials washed from the gas stream. Scrubbing solutions are often aqueous, however may comprise, or also comprise reagents depending on the materials to be removed from a gas stream. The water component in an aqueous scrubbing solution may comprise fresh water, deionized water, potable or un-potable water, sea water, wastewater, bilge water, aqueous solutions, and the like, depending on the intended purpose.

In an embodiment of the present invention, a method of treating wastesolution from scrubber systems is provided. The method includes the step of receiving scrubber wastesolution. The method further includes the step of delivering the wastesolution to a biogenerator which utilizes cultured hydrocarbon degrading microorganisms to reduce a concentration of emulsified oil in the wastesolution. In some embodiments, the hydrocarbon degrading microorganisms are halotolerant or halophilic. The microorganisms may be used to reduce a concentration of petroleum hydrocarbon or poly nuclear aromatic hydrocarbons in the received wastesolution. The microorganisms may be used to reduce a concentration of emulsified oil, Ammonia Nitrogen (NH₄—N), Nitrate Nitrogen (N0₃-N), Nitrite Nitrogen (N0₂-N), Total Nitrogen (TN), Chemical Oxygen Demand (COD), and/or Biological Oxygen Demand (BOD) in the wastesolution. In some embodiments, the contaminant concentration may be optionally measured at an outlet of the biogenerator. Optionally, various steps of the method may be repeated if the contaminant concentration is measured above a threshold value.

In some embodiments, the method includes an optional step of reducing an amount of free phase oil in the wastesolution. The optional step of reducing an amount of free phase oil in the wastesolution may be repeated. Further, the wastesolution may be redelivered to the biogenerator and then the steps of reducing an amount of free phase oil and reducing a concentration of particulates in the received wastesolution may be repeated.

In certain embodiments, the method may include discharging the wastesolution when the contaminant concentration in the wastesolution is below a threshold value. Optionally, the method may include the step of discharging the wastesolution to a storage container for future disposal when the wastesolution is below a threshold value. The measured contaminant concentration may be a concentration of polynuclear aromatic hydrocarbons, petroleum hydrocarbons, alcohols, aromatics, hydraulic fluids, solvents, detergents, synthetic oils, lubricants, or a combination thereof. In some embodiments, the received wastesolution may be from a shipboard EGC system and may also include bilge solution. In other embodiments, the received wastesolution may be from a terrestrial EGC system.

The treated wastesolution must meet regulatory levels to be discharged from shipboard systems. Currently, the turbidity of the discharge must be below 25 NTU. The methods and systems described herein can reduce the turbidity of a wastesolution from a range of 500 to 1800 NTU to less than 25 NTU. The total suspended solids (TSS) must also be reduced to permit discharge of the treated wastesolution. The methods and systems described herein can reduce the TSS of a wastesolution from a range of 500 ppm to less than 100 ppm.

In some embodiments, the method of treating a wastesolution may include mixing the wastesolution with a coagulant and a flocculant. The method further includes separating a concentration of solids from the wastesolution using a clarifier. The solids may include particulate matter which includes at least one of soot, PM_{2.5}, PM₁₀, unburned fuel, partially combusted materials, arsenic, iron, vanadium, copper, rust, and/or iron oxides. A supernatant of the wastesolution from the clarifier is delivered to a filtration unit to reduce the concentration of particulate matter in the wastesolution. Optionally, the solids collected from the clarifier may be dewatered and sent to a holding tank.

In some embodiments, the method of treating wastesolution may reduce a concentration of particulates in the wastesolution by using a hydrocyclone, a backflushing filter, a centrifuge, a filter-cartridge, a screen-filter, and/or a disk-filter. In another embodiment, an optional granulated activated carbon filter may be used.

In another embodiment of the present invention, a wastesolution treatment system for treating wastesolution is provided. The system may include a biogenerator configured to receive wastesolution and to culture hydrocarbon degrading microorganisms. The hydrocarbon degrading microorganisms may reduce an amount of at least one of emulsified oil, Ammonia Nitrogen (NH₄—N), Nitrate Nitrogen (N0₃-N), Nitrite Nitrogen (N0₂-N), Total Nitrogen (TN), Chemical Oxygen Demand (COD), and/or Biological Oxygen Demand (BOD) in the wastesolution. In some embodiments, the biogenerator may include a wastesolution inlet for receiving wastesolution, a gas inlet for receiving gases into the biogenerator to support the growth of cultured hydrocarbon degrading microorganisms, and a nutrient inlet for receiving nutrients into the biogenerator to support the growth of cultured hydrocarbon degrading microorganisms.

In some embodiments, the system may optionally include a pretreatment system coupled to the biogenerator. The pretreatment system may be configured to pretreat received wastesolution using an oil/water separator. The oil/water separator may be configured to reduce free phase oil in the received wastesolution. The coupled biogenerator may receive the pretreated wastesolution and may be configured to culture hydrocarbon degrading microorganisms so as to reduce a concentration of emulsified oil in the received wastesolution.

In another embodiment of the present invention, the wastesolution treatment system for treating wastesolution may include a first stage treatment system, a second stage treatment system, and a third stage treatment system. The first stage treatment system may be configured to mix the wastesolution with a coagulant and a flocculant. The first stage system may include a coagulant storage tank and a flocculant storage tank. The first stage system may also include a mixing tank. The first stage system may optionally include a pH adjustment system. The second stage treatment system may be configured to separate a concentration of solids from the wastesolution. The second stage system may include a clarifier to separate a concentration of solids from the wastesolution. The solids separated include particulate matter of soot, PM_{2.5}, PM₁₀, unburned fuel, partially combusted materials, arsenic, iron, vanadium, copper, rust, and/or iron oxides. The second stage system may include a first holding tank to collect the solids separated from the wastesolution. The second stage may optionally include a dewatering system to dewater the solids separated from the wastesolution. The third stage treatment system may include a filtration unit to further reduce the concentration of particulate matter in the wastesolution and a pump to discharge a filtered wastesolution. The filtration unit may be a hydrocyclone, a backflushing filter, a centrifuge, a filter-cartridge, a screen filter, a disk-filter or a combination thereof. Optionally, the system may include a granulated activated carbon filter.

In some embodiments, the wastesolution treatment system may optionally include a monitor coupled to the outlet of the system. The monitor may be configured to measure a contaminant concentration in the wastesolution. In some embodiments, a pump may optionally be coupled to the outlet of the biogenerator so as to receive the wastesolution after the wastesolution has flowed through the biogenerator. In some embodiments, a pump may optionally be coupled to the outlet of the filtration unit so as to receive the wastesolution after the wastesolution has flowed through the filtration unit. The pump may recirculate the wastesolution through the system when the monitor measures a contaminant concentration in the wastesolution above a threshold value. In some embodiments, the wastesolution is recirculated to the biogenerator. In other embodiments, the wastesolution is recirculated to the first stage treatment system. Further, the pump may optionally be configured to discharge the wastesolution from the system or to a storage container when the monitor measures a contaminant concentration in the wastesolution below a threshold value.

The wastesolution treatment system may monitor the concentration of polynuclear aromatic hydrocarbons, petroleum hydrocarbons, alcohols, aromatics, hydraulic fluids, solvents, detergents, synthetic oils, and/or lubricants in the treated solution. In some embodiments, the wastesolution is received from a shipboard Exhaust Gas Cleaning (“EGC”) system which may also include bilge solution. In other embodiments, the wastesolution is received from a terrestrial EGC system.

In some embodiments, the system may further include a gas pump coupled to a gas inlet of the biogenerator so as to introduce gas into the biogenerator. The gas pump may be a fine bubble diffuser, a slotted pipe, a compressed gas pump, or a dissolved air floatation pump. Optionally, the system may include a nutrient pump coupled to a nutrient inlet of the biogenerator so as to introduce nutrients into the biogenerator. The nutrients may be configured to support the growth of cultured microorganisms.

In yet another embodiment of the present invention, a solution treatment system for use with a terrestrial EGC system is provided. The system includes a biogenerator configured to receive wastesolution and configured to culture hydrocarbon degrading microorganisms. The biogenerator includes a wastesolution inlet for receiving wastesolution, a gas inlet for receiving gases to support the growth of cultured hydrocarbon degrading microorganisms, and a nutrient inlet for receiving nutrients into the biogenerator to support the growth of cultured hydrocarbon degrading microorganisms. The cultured hydrocarbon degrading microorganisms reduce an amount of emulsified oil, Ammonia Nitrogen (NH₄—N), Nitrate Nitrogen (N0₃-N), Nitrite Nitrogen (N0₂-N), Total Nitrogen (TN), Chemical Oxygen Demand (COD), and/or Biological Oxygen Demand (BOD) in the wastesolution. A monitor may be coupled to an outlet of the biogenerator so as to receive wastesolution from the biogenerator. The monitor may measure the contaminant concentration level in the received wastesolution. Contaminants include polynuclear aromatic hydrocarbons, petroleum hydrocarbons, soot, alcohols, aromatics, hydraulic fluids, solvents, detergents, synthetic oils, and lubricants. The system may include a pump coupled to the outlet of the biogenerator. The pump may be configured to discharge wastesolution received from the biogenerator out of the wastesolution treatment system when the monitor measures the contaminant concentration level below a threshold value and may be further configured to recirculate the wastesolution to the biogenerator when the monitor measures the contaminant concentration level above a threshold value. Alternatively, the pump may be configured to discharge wastesolution received from the biogenerator to a storage tank for later disposal when the contaminant concentration level is measured below the threshold value. In some embodiments, the wastesolution may include scrubber wastesolution.

In another embodiment of the present invention, a solution treatment system for use with a shipboard EGC system is provided. The system includes a first stage treatment system configured to receive wastesolution and further configured to mix the wastesolution with a coagulant and a flocculant. The first stage treatment system may include a coagulant storage tank, a flocculant storage tank, a mixing tank, a coagulant transfer pump, and a flocculant transfer pump. The system may optionally include a pH adjustment system that includes a pH monitoring device, a first storage vessel containing an acid, a second storage vessel containing a base, and a transfer pump system. The solution treatment system also includes a second stage treatment system configured to separate a concentration of solids from the wastesolution. The second stage treatment system may include a clarifier and a first holding tank to collect the solids separated from the wastesolution. The system may optionally include a dewatering system to dewater the solids separated from the wastesolution. The dewatering system may include a second holding tank for the dewatered solids. The solids separated from the wastesolution may include particulate matter which includes soot, PM_{2.5}, PM₁₀, unburned fuel, partially combusted materials, arsenic, iron, vanadium, copper, rust, and/or iron oxides. The solution treatment system also includes a third stage treatment system configured to reduce a concentration of solids from the wastesolution. The third stage treatment system may include a filtration unit, a pump to discharge a filtered wastesolution, a monitor coupled to an outlet of the filtration unit, and a recirculation pump. The filtration unit may include a hydrocyclone, a backflushing filter, a centrifuge, a filter-cartridge, a screen-filter, and/or a disk-filter. The filtration unit may also include a granulated activated carbon filter, the granulated activated carbon filter utilizing granulated activated carbon to reduce a concentration of contaminants from the wastesolution. The monitor may be configured to measure a contaminant concentration in the wastesolution at the outlet of the filtration unit. The contaminant concentration may include at least one of a polynuclear aromatic hydrocarbons, soot, petroleum hydrocarbons, alcohols, aromatics, hydraulic fluids, solvents, detergents, synthetic oils, and/or lubricants. The recirculation pump may be configured to recirculate the wastesolution to the first stage treatment system from the filtration unit when the monitor measures a contaminant concentration in the wastesolution above a threshold value and further configured to discharge the wastesolution from the system when the monitor measures a contaminant concentration in the wastesolution below a threshold value.

### BRIEF DESCRIPTION OF THE DRAWINGS

FIG. 1 depicts an exemplary modified system according to some embodiments of the present invention.

FIG. 2 depicts a flow chart representing an exemplary method exhaust gas cleaning method according to certain embodiments of the present invention.

FIG. 3 depicts an exemplary method of treating wastesolution according to some embodiments of the present invention.

FIG. 4 illustrates an exemplary embodiment of a wastesolution treatment system.

FIG. 5 depicts an exemplary method of treating wastesolution according to some embodiments of the present invention.

FIG. 6 illustrates an exemplary embodiment of a wastesolution treatment system.

FIG. 7 illustrates an exemplary embodiment of a wastesolution treatment system.

### DETAILED DESCRIPTION OF THE INVENTION

In the following description, various embodiments of the present invention will be described. For purposes of explanation, specific configurations and details are set forth in order to provide a thorough understanding of the embodiments. However, it will also be apparent to one skilled in the art that the present invention may be practiced without the specific details. Furthermore, well-known features may be omitted or simplified in order not to obscure the embodiment being described.

Embodiments of wastesolution treatment systems and methods may be used to treat various types of solution such as scrubber wastesolution or bilge solution. The system components and size may vary depending on, for example, the intended use, the amount of solution being treated, and the types of contaminants being treated. Although embodiments described herein are generally directed to treating scrubber wastesolution for Exhaust Gas Cleaning (“EGC”) systems, it should be understood that there is no intention to limit the invention to the type of solution to be treated. Accordingly, the invention described herein should be limited only by the language of the claims.

As noted above, embodiments of the present invention may be particularly advantageous for treating scrubber wastesolutions produced, for example, in a wet scrubbing process wherein a scrubbing solution is utilized to wash materials, such as pollutants, from a gas stream. Certain embodiments of the methods and/or the systems of the present invention comprise methods and/or systems for the physical separation of petroleum hydrocarbons (“PHCs”) from scrubber wastesolutions. Certain embodiments of the methods and/or systems comprise methods and/or systems for microbiological remediation of the petroleum and the biodegradable materials in the scrubber wastesolution. Some embodiments of the present invention may be used with existing EGC systems. In some embodiments, a biogenerator with hydrocarbon degrading microorganisms may be utilized to reduce the amount of emulsified hydrocarbons in the wastesolution. In other embodiments, a clarifier and filtration unit may be utilized to reduce the amount of hydrocarbons in the waste solution.

In some embodiments, it may be preferable to utilize a granulated activated carbon (“GAC”) biofilter to reduce the amount of contaminants in the scrubber wastesolution. The GAC biofilter may also utilize hydrocarbon degrading microorganisms to reduce the amount of emulsified oil in the scrubber wastesolution.

In some embodiments of the present invention, the systems and methods may be used in terrestrial EGC systems. In further embodiments, the systems and methods may be used in a shipboard or maritime EGC system. Further, some systems and methods may be used to treat scrubber wastesolution and bilge solution on board a maritime vessel. In certain embodiments, the method to treat wastesolution may be continuous.

For example, an embodiment of the present invention may be provided for use with a shipboard EGC system. The scrubber wastesolution treatment system may receive scrubber wastesolution containing pollutants. The pollutants may include PHCs, polynuclear aromatic hydrocarbons (“PAHs”), and particulate matter (“PM”). The wastesolution treatment system may utilize a mix tank to mix the wastesolution with a coagulant and a flocculant. The wastesolution treatment system may also use a clarifier to remove solids that include particulate matter from the wastesolution. The supernatant of the wastesolution may then be sent through a filtration unit which further removes solids from the wastesolution. This embodiment may also utilize a dewatering system. The dewatering system may reduce the amount of water in the solids separated in the clarifier. This embodiment may also use a pH adjustment system to maintain a pH range in the mix tank.

In another embodiment, the scrubber wastesolution treatment system may utilize an oil/water separator to remove free phase oil from the scrubber wastesolution. The wastesolution may be flowed through a biogenerator which cultures hydrocarbon degrading microorganisms. The microorganisms may reduce the amount of emulsified oil in the wastesolution. In certain embodiments, halotolerant or halophilic microorganism cultures may be preferred because the initial scrubber solution may be ocean water or other water with high salt content. In some embodiments, the wastesolution may have a saline concentration above 3%.

Further, the exemplary embodiment may be configured to treat bilge solution in a similar fashion. After treating the solution, some embodiments may safely discharge the treated wastesolution to surface water bodies, store the treated wastesolution for future disposal or recirculate the treated wastesolution back into the EGC system. The contaminants removed by the system may be separately stored for proper disposal.

Although this exemplary embodiment has been described in great detail above, many variations are available. Further features of the invention, its nature, and various advantages will be more apparent from the accompanying drawings and the following description.

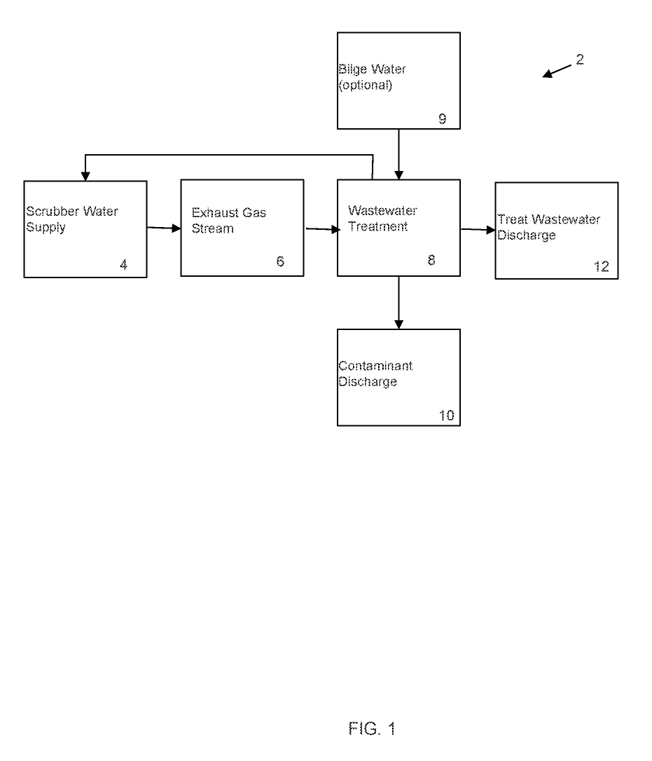

An embodiment of a wastesolution treatment system of the present invention may be used with current EGC systems and methods. As an example, an exemplary modified EGC system 2 is represented at a high level in FIG. 1. Referring to FIG. 1, EGC system 2 includes scrubber solution supply 4, exhaust gas stream 6, wastesolution treatment 8, contaminant discharge 10, and treated wastesolution discharge 12. As shown in FIG. 1, scrubber solution supply 4 is coupled to exhaust gas stream 6. The scrubber solution is delivered to exhaust gas stream 6 to capture and absorb pollutants in exhaust gas stream 6. A portion of wastesolution from cleaning exhaust gas stream 6 may be recirculated back to scrubber solution supply 4 and another portion may be delivered to wastesolution treatment system 8. In some embodiments, wastesolution treatment system 8 may receive bilge solution 9. Wastesolution treatment system 8 reduces the amount of contaminants in the received solution and discharges separated contaminants in contaminant discharge 10. Wastesolution treatment system 8 then discharges treated wastesolution to treated solution discharge 12 and/or recirculates the treated wastesolution back to scrubber solution supply 4. The treated wastesolution discharge 12 may optionally be stored in wastesolution discharge 7, be recirculated back to scrubber solution supply 4, or be discharged entirely from EGC system 2 depending on the particular embodiment.

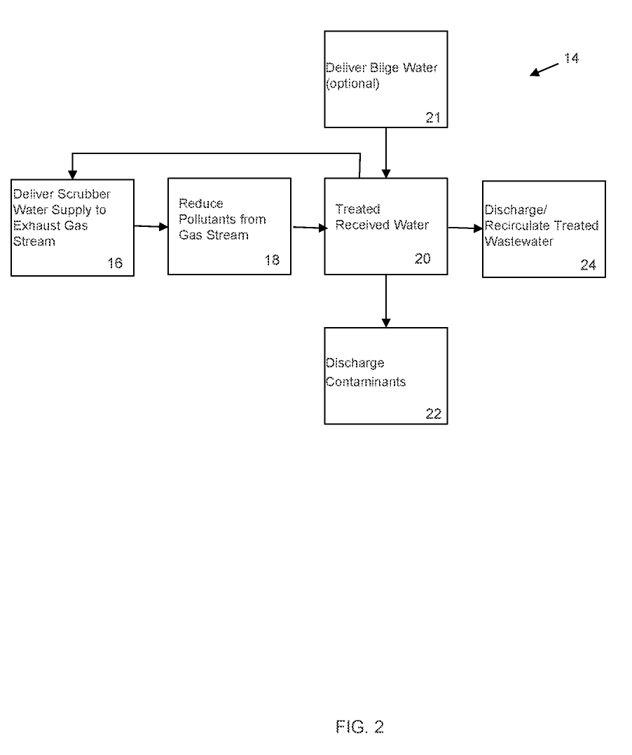

FIG. 2 provides a high-level flow diagram of an exemplary modified process 14 used in EGC system 2. At step 16, scrubber solution is delivered to the exhaust gas stream. In some embodiments the scrubber solution may be delivered as a fine mist into the exhaust gas stream. In certain embodiments the exhaust gas stream may be passed through a pool of the scrubber solution. At step 18, the scrubber solution contacts the pollutants in the exhaust gas stream. The scrubber solution may capture and adsorb particulates and gaseous pollutants. At step 20, after the scrubber solution captures and adsorbs the pollutants from the exhaust gas stream, the scrubber wastesolution is treated. In some embodiments, where bilge treatment system and scrubber solution treatment system are combined, bilge solution may be delivered 21 for treatment 20. The received solution may be treated by removing contaminants and solid pollutants from the wastesolution. The separated contaminants may be discharged 22 and may be stored separately for proper disposal. The treated wastesolution may then be safely discharged 24 where it may be removed from the system, stored for later disposal, or may be recirculated and reused in the EGC system depending on the particular embodiment.

In some embodiments, EGC system 2 and modified process 14 may be used in terrestrial exhaust gas streams to limit the pollutants released into the air and to limit the pollutants released into the ground waters. In other embodiments, EGC system 2 and modified process 14 may be used on board a maritime ship to limit pollutants from internal combustion machinery from entering the open surface waters. In further embodiments, EGC system 2 and modified process 14 may be used on board a maritime ship to reduce the concentration of pollutants in bilge solution and/or scrubber wastesolution. The modified systems and methods may be open loop, closed loop, or hybrid systems. For example, in some embodiments wastesolution treatment system 8 recirculates treated wastesolution back to scrubber solution supply 4. In some embodiments, particularly shipping vessel EGC systems, treated wastesolution discharge 12 may be discharged to open waters. In some embodiments, treated wastesolution discharge 12 may be stored for future disposal. Similarly, contaminant discharge 10 may store separated contaminants for future disposal.

Scrubber solution supply 4 may comprise sea water when EGC system 2 is onboard a maritime ship. Alternatively, scrubber solution supply 4 may be a freshwater source supplemented with an alkaline or caustic additive such as sodium hydroxide. The alkaline additive may assist in neutralizing pollutants from exhaust gas stream 6. Exhaust gas stream 6 may be from various types of combustion processes, chemical processes, or mechanical processes. Exhaust gas stream 6 may be polluted with nitrous oxide (NOₓ), sulfur oxide (SOₓ), and ozone depleting pollutants. In some embodiments, exhaust gas stream may include particulate pollutants as well. For example, exhaust gas stream 6 of a ship's internal combustion engine may comprise sulfur oxides of approximately 95% sulfur dioxide and about 5% sulfur trioxide. Additionally, soot, dust, unburned fuel, and other particulates may be present in the exhaust gas stream. Some diesel engine emissions may contain approximately 3.21 g/kW·hr of particulate matter. In some embodiments the scrubber wastesolution may contain approximately 58% of these particles.

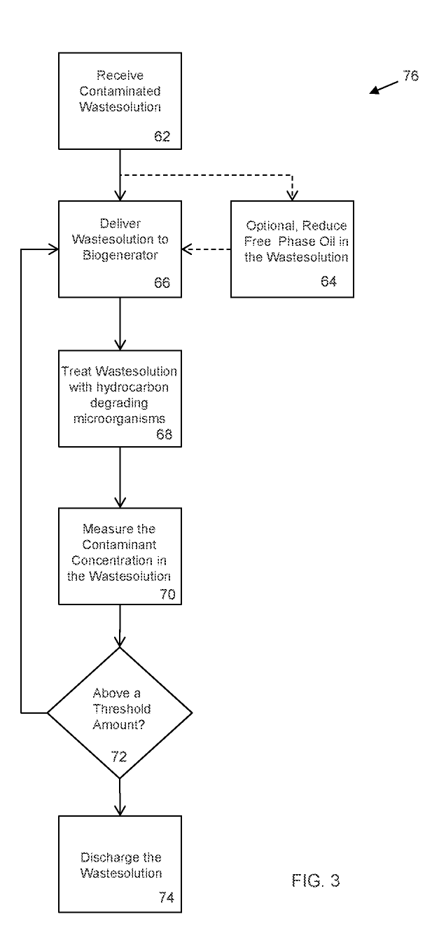

Embodiments of the present invention may be directed to systems and methods for treating scrubber wastesolution. In some embodiments, bilge solution may also be treated using systems and methods of the present application. For example, in some embodiments, wastesolution treatment system 8 and treatment step 20 of process 14 may reduce the amount of petroleum hydrocarbons, polynuclear aromatic hydrocarbons, alcohols, aromatics, hydraulic fluid, solvents, detergents, synthetic oils and/or lubricants in received wastesolution. In some embodiments, the scrubber wastesolution may include 400 ppm of unburned hydrocarbons and 16.5 ppm PAHs. Wastesolution treatment system 8 and treatment step 20 of process 14 may be configured to remove particulates from the scrubber wastesolution. For example, soot, fine particles (PM_{2.5}), coarse particles (PM₁₀), unburned fuel, partially combusted materials, arsenic, iron, copper, rust and iron oxides may be removed from the received solution. Some embodiments may remove approximately 90-95% of the particulates above 10 μm and approximately 20%-50% of the particulates between 1 and 10 μm. Some embodiments may remove PAHs to below 50 ppb. Some embodiments achieve the disclosed level of contaminant reduction with hydraulic retention times less than 30 minutes. Treatment system 8 and treatment step 20 are discussed further with FIGS. 3-7 below.

FIG. 3 provides an exemplary method 76 of treating solution 20 according to some embodiments of the present invention. At step 62, scrubber wastesolution and/or bilge solution is received from EGC system 2. At step 64, the free phase oil may be reduced in the received solution(s). At step 66, the solution may be delivered into a biogenerator with hydrocarbon degrading microorganisms. The hydrocarbon degrading microorganisms may reduce the amount of emulsified oil in the received solution 68. At step 70, the contaminant concentrations in the solution are measured to determine whether the contaminant concentrations exceed a certain threshold 72. If the contaminant concentration exceeds a set threshold, various steps in the process may be repeated. Some embodiments may reintroduce the solution back into the biogenerator to further reduce the amount of emulsified oil in the received solution 66. When the contaminant concentration is measured below a set threshold value, the treated solution may be discharged/disposed 74 from the treatment system. From step 74, the treated solution may be recirculated back to EGC system 2 and reused as scrubber solution, may be discharged into a storage tank for future disposal, or may be discharged entirely from the EGC system 2.

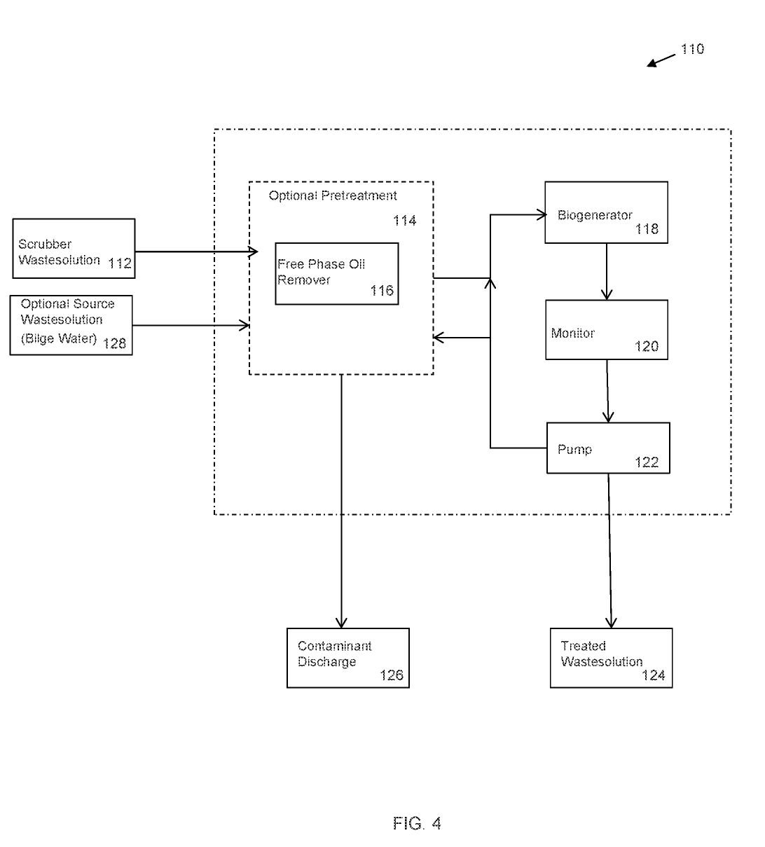

FIG. 4 depicts an exemplary wastesolution treatment system 110. In this particular embodiment, scrubber wastesolution 112 and bilge solution 128 may be received by pretreatment system 114. Pretreatment system 112 includes free phase oil remover 116 which reduce the concentration of particulates and free phase oil in received wastesolution 112 and/or bilge solution 128. Free phase oil may be discharged from the system and stored in a separate container 126 for future disposal. Pretreatment system 114 is coupled to biogenerator 118 so as to provide wastesolution to biogenerator 118. Biogenerator 118 may utilize a fixed film culture of hydrocarbon degrading microorganism to reduce the concentration of emulsified oil in the scrubber wastesolution 112 and/or bilge solution 128. After the received wastesolution has been treated, the contaminants may be measured. Pump 122 and monitor 120 may direct the treated wastesolution according to the measured concentration of contaminants. Monitor 120 is coupled to an outlet of biogenerator 118 so as to measure the concentration of contaminants in the treated wastesolution. The wastesolution may be discharged from the system when the contaminant concentrations are below a threshold value. The treated wastesolution 124 may be recirculated back into the EGC system and reused as scrubber solution. For example, in some embodiments used onboard maritime vessels, the treated wastesolution may be safely discharged overboard. If the measured concentrations of contaminants are above a threshold value, pump 122 may redirect the scrubber wastesolution to pretreatment system 114 or biogenerator 118 for further treatment.

As set forth above, in some embodiments, oil may be physically separated and removed from the scrubber wastesolution using an oil/water separator 116. Separator 116 may comprise API oil-water separators, hydrocyclones, oleophilic filters, coalescing resin beads or other coalescing media, fiberglass filters, hollow fiber membranes, or flocking particles to separate oil from the wastesolution. These separator systems 116 may be used individually or in combination to separate petroleum products from the scrubber wastesolution. An oil/water separator may reduce the amount of hydrocarbons in the wastesolution before the wastesolution reaches the biogenerator. This may be preferable because high levels of hydrocarbons in the wastesolution may be toxic or indigestible to microorganisms.

Biogenerator 118 may be used in some embodiments of the invention to reduce the amount of emulsified oil in the scrubber wastesolution 112 and/or bilge solution 128. Scrubber wastesolution 112 and bilge solution 128 may have high concentrations of emulsified oil for various reasons. In some embodiments, the received solution may include emulsified oil due to the presence of engine-cleaning detergents, engine oil and jacket water additives, and other substances that emulsify oil into the received solution. In other embodiments, the solution may include emulsified oil due to pumping systems and other mechanical agitations which facilitate oil emulsification into the aqueous phase. Biogenerator 118 may utilize hydrocarbon degrading microorganisms to reduce the amount of emulsified oil in the wastesolution. Such microorganisms may reduce the concentration of PHCs and PAHs in the wastesolution. The biogenerator 118 may reduce an amount of Ammonia Nitrogen (NH₄—N), Nitrate Nitrogen (N0₃-N), Nitrite Nitrogen (N0₂-N), Total Nitrogen (TN), Chemical Oxygen Demand (COD), and/or Biological Oxygen Demand (BOD) in the wastesolution 112.

A fixed film biogenerator 118 may be used in some embodiments where the wastesolution is continually removed from the system to ensure that the hydrocarbon degrading microorganisms remain present in the system. Some embodiments may utilize an anoxic bioreactor. Some embodiments may further add a separate carbon source to the anoxic reactor to aid in biological degradation of the wastesolution. Certain embodiments may use a PVC type matrix composition. In other embodiments, the matrix may comprise plastic, metal ceramic, glass, or other suitable material for the adherence of microorganisms. In some embodiments, biogenerator 118 may use top-down flow through the reactor. The retention time may depend on the concentration and types of contaminants in the wastesolution. In some embodiments, the retention may be below 30 minutes and achieve reduction of contaminants below regulatory levels. The mineralization process may begin in biogenerator 118 where more simple hydrocarbons are oxidized into harmless end products. Microbes may be initially inoculated in the reactor and left to populate the media. During operation, the microbes may continually replenish themselves in the reactor while some of them may slough off the media.

In some embodiments, halotolerant or halophilic hydrocarbon degrading microorganisms are cultured in the biogenerator 118. The microorganisms may be developed from the natural selection of microbes that have been proven to degrade petroleum components in bench-scale operations in high salinity environments. These embodiments may be particularly effective in maritime EGC systems which utilize ocean saltwater as scrubber solution.

In certain embodiments, the biogenerator 118 may include a nutrient pump which continually delivers beneficial nutrients to the hydrocarbon degrading microorganisms. The nutrient pump may be automated to help maintain an optimal environment for sustaining a hydrocarbon degrading microorganism culture. In further embodiments, a biogenerator may include a gas inlet coupled to a gas pump which delivers beneficial gases to the hydrocarbon degrading microorganisms. The gas pump may be a fine bubble diffuser, a slotted pipe, a compressed gas pump, or a dissolved air floatation pump. The gas pump may similarly be automated to help maintain an optimal environment for sustain a hydrocarbon degrading microorganism culture. For example, some embodiments may control nitrogen, phosphate, and/or oxygen delivery into the biogenerator and/or biofilter to better ensure that the hydrocarbon degrading microorganisms may completely metabolize petroleum hydrocarbons in the wastesolution. Biogenerator 118 may further include a pH controller which monitors and maintains pH levels between about 6 and 8 for optimizing growth conditions for some microorganisms.

In some embodiments, a monitor 120 may be used to measure the amount of contaminants in the wastesolution after treatment. In some embodiments, the wastesolution is recirculated back into the wastesolution treatment system when the monitor detects a contaminant concentration above a set threshold. In some embodiments the wastesolution may be discharged from the system when the monitor detects a contaminant concentration below the set threshold. For example, in some embodiments, the wastesolution may be safely discharged into open waters when measured PAH concentrations are less than 50 μg/L. In further embodiments, the wastesolution may be recirculated into the EGC system when the monitor detects a contaminant concentration below the set threshold. In some embodiments the wastesolution may be directed to a storage tank for later disposal. In some embodiments, the EGC system is shipboard. In other embodiments, the EGC is terrestrial.

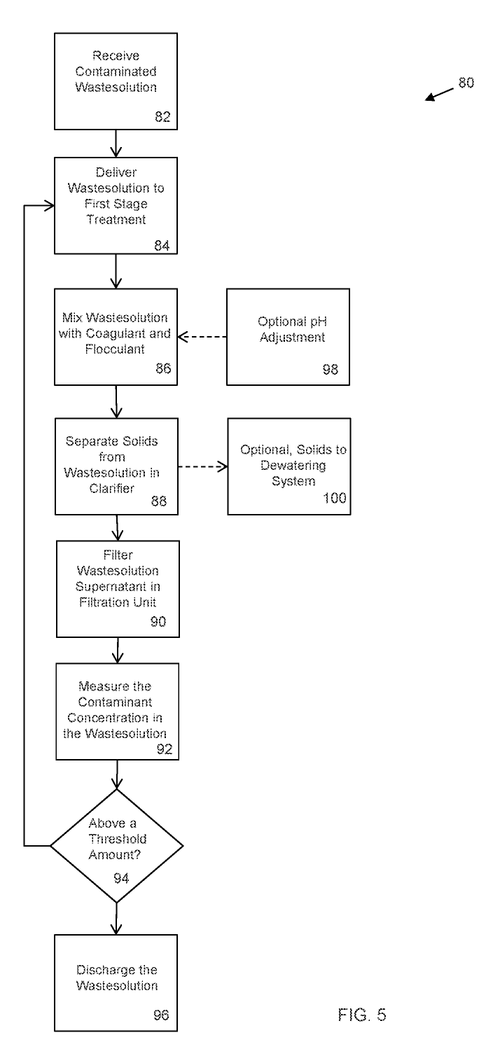

FIG. 5 provides an exemplary method 80 of treating solution 20 according to some embodiments of the present invention. At step 82, scrubber wastesolution and/or bilge solution is received from EGC system 2. At step 84, the solution may be delivered into a first stage treatment system where the wastesolution may be mixed 86 with a flocculant and a coagulant. At step 88, the wastesolution/coagulant/flocculant is transferred to a clarifier to separate solids from the wastesolution. At step 90, the supernatant from the clarifier is transferred to the filtration unit for further reduction in contaminants. Some embodiments include step 98 to adjust pH to maintain a target pH range in the mixing step 86. In some embodiments, an optional dewatering step 100 is included. At step 92, the contaminant concentrations in the solution are measured to determine whether the contaminant concentrations exceed a certain threshold 94. If the contaminant concentration exceeds a set threshold, various steps in the process may be repeated. Some embodiments may reintroduce the solution back into the first stage treatment to further reduce the amount of contaminants in the received solution 84. When the contaminant concentration is measured below a set threshold value, the treated solution may be discharged/disposed 96 from the treatment system. From step 96, the treated solution may be recirculated back to EGC system 2 and reused as scrubber solution, may be discharged into a storage tank for future disposal, or may be discharged entirely from the EGC system 2. In some embodiments, the EGC system is shipboard. In other embodiments, the EGC is terrestrial.

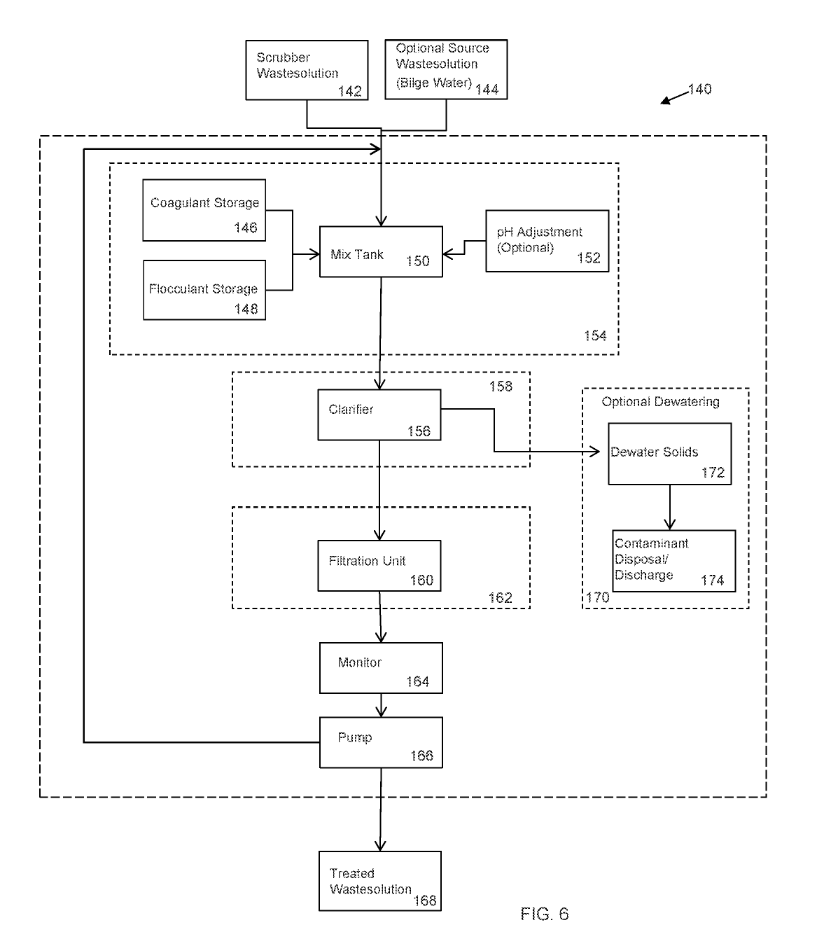

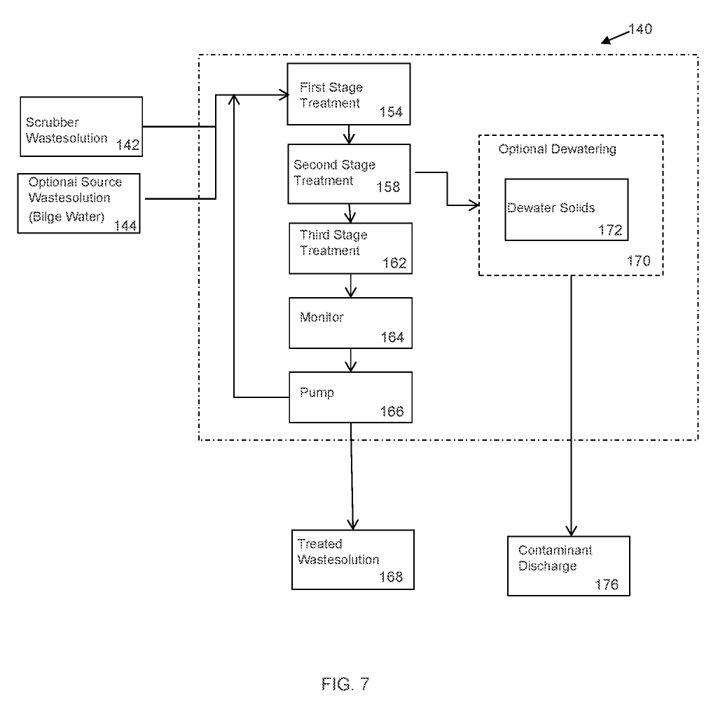

FIGS. 6 and 7 depict an exemplary wastesolution treatment system 140. In this particular embodiment, scrubber wastesolution 142 and bilge solution 144 may be received by first stage treatment system 154. The first stage treatment system 154 may include coagulant storage and transfer 146, flocculant storage and transfer 148, and mix tank 150. In some embodiments, a pump is used to transfer the coagulant to the mix tank. In some embodiments, a pump is used to transfer the flocculant to the mix tank. A pH adjustment system 152 may also be included to maintain a target pH. First stage treatment system 154 is coupled to second stage treatment system 158. The second stage treatment system includes a clarifier 156 to separate solids from the wastesolution 142 and/or bilge solution 144. The solids may include particulate matter which includes at least one of soot, fine particles (PM_{2.5}), coarse particles (PM₁₀), unburned fuel, partially combusted materials, arsenic, iron, vanadium, copper, rust, and/or iron oxides. After the received wastesolution has been separated in the clarifier 156, the wastesolution supernatant is transferred to the third stage treatment system 162 that includes filtration unit 160. The wastesolution supernatant is filtered in the filtration unit 160 and then transferred to the monitor 164 to measure the contaminant concentration in the wastesolution. Pump 166 and monitor 164 may direct the treated wastesolution according to the measured concentration of contaminants. Monitor 164 is coupled to an outlet of filtration unit 160 so as to measure the concentration of contaminants in the treated wastesolution. The wastesolution may be discharged from the system when the contaminant concentrations are below a threshold value. The treated wastesolution 168 may be recirculated back into the EGC system and reused as scrubber solution. For example, in some embodiments used onboard maritime vessels, the treated wastesolution may be safely discharged overboard. If the measured concentrations of contaminants are above a threshold value, pump 166 may redirect the scrubber wastesolution to first stage treatment system 154 for further treatment. The solids from the clarifier 156 may be further processed in an optional dewatering system 170 and holding tank 174 for disposal.

In some embodiments, the pH adjustment system 152 includes a pH monitoring device, a first storage vessel containing an acid, a second storage vessel containing a base, and a pump system to transfer the acid and/or the base to the mixing tank. The pH adjustment system 152 may be utilized to maintain a target pH.

In some embodiments of the invention clarifier 156 may be used in conjunction with the coagulant and flocculant to reduce the amount of emulsified oil in the scrubber wastesolution 142 and/or bilge solution 144. Scrubber wastesolution 142 and bilge solution 144 may have high concentrations of emulsified oil for various reasons. In some embodiments, the received solution may include emulsified oil due to the presence of engine-cleaning detergents, engine oil and jacket water additives, and other substances that emulsify oil into the received solution. In other embodiments, the solution may include emulsified oil due to pumping systems and other mechanical agitations which facilitate oil emulsification into the aqueous phase. In some embodiments, filtration unit 160 may be used to further remove solids from the wastesolution. Filtration unit 160 may be a hydrocyclone, a backflushing filter, a screen-filter, a centrifuge, a filter-cartridge, and a disk-filter. Filtration unit 160 may remove soot, fine particles (PM_{2.5}), coarse particles (PM₁₀), unburned fuel, partially combusted materials, arsenic, iron, copper, rust and iron oxides from the wastesolution. In some embodiments, a granulated activated carbon filter may be used. The granulated activated carbon filter may utilize granulated activated carbon to reduce a concentration of contaminants from the wastesolution. The granulated activated carbon may sequester the PAHs and provide a higher level of reduction as compared to other processes. The particulates removed from the wastesolution may be discharged and stored separately for proper disposal.

In some embodiments, a monitor 164 may be used to measure the amount of contaminants in the wastesolution after treatment. In some embodiments, the wastesolution is recirculated back into the first stage treatment system 154 when the monitor detects a contaminant concentration above a set threshold. The contaminant concentration may include polynuclear aromatic hydrocarbons, petroleum hydrocarbons, alcohols, aromatics, hydraulic fluids, solvents, detergents, synthetic oils, and/or lubricants. In some embodiments the wastesolution may be discharged from the system when the monitor detects a contaminant concentration below the set threshold. For example, in some embodiments, the wastesolution may be safely discharged into open waters when measured PAH concentrations are less than 50 μg/L. In further embodiments, the wastesolution may be recirculated into the EGC system when the monitor detects a contaminant concentration below the set threshold. In some embodiments the wastesolution may be directed to a storage tank for later disposal. In some embodiments, the method of wastesolution treatment is continuous in nature.

While the invention is susceptible to various modifications and alternative constructions, certain illustrated embodiments thereof are shown in the drawings and described above in detail. It should be understood, however, that there is no intention to limit the invention to the specific form or forms disclosed, but on the contrary, the intention is to cover all modifications, alternative constructions, and equivalents falling within the spirit and scope of the invention, as defined in the appended claims.

### Illustrative Embodiments of Suitable Methods, Products, and Systems.

As used below, any reference to methods, products, or systems is understood as a reference to each of those methods, products, or systems disjunctively (e.g., “Illustrative embodiment 1-4 is understood as illustrative embodiment 1, 2, 3, or 4.”).

Illustrative embodiment 1 is a method of treating a wastesolution containing salt concentrations above 2%, the method comprising:
(a) receiving the wastesolution;
(b) mixing the wastesolution with a coagulant and a flocculant; and
(c) separating a concentration of solids from the wastesolution using a clarifier, wherein the solids include particulate matter which includes at least one of soot, PM_{2.5}, PM₁₀, unburned fuel, partially combusted materials, arsenic, iron, vanadium, copper, rust, and/or iron oxides; and
(d) delivering a supernatant of the wastesolution from the clarifier to a filtration unit to further reduce the concentration of particulate matter in the wastesolution.

Illustrative embodiment 2 is the method of any preceding or subsequent illustrative embodiment, wherein the solids are collected from the clarifier, dewatered, and sent to a holding tank.

Illustrative embodiment 3 is the method of any preceding or subsequent illustrative embodiment, wherein the filtration unit is a granulated activated carbon filter, the granulated activated carbon filter utilizing granulated activated carbon to reduce a concentration of contaminants from the wastesolution.

Illustrative embodiment 4 is the method of any preceding or subsequent illustrative embodiment, wherein the filtration unit reduces the concentration of particulate matter in the wastesolution by utilizing at least one of a hydrocyclone, a backflushing filter, a centrifuge, a filter-cartridge, a screen-filter, and/or a disk-filter.

Illustrative embodiment 5 is the method of any preceding or subsequent illustrative embodiment, further comprising measuring a contaminant concentration in the wastesolution at an outlet of the filtration unit.

Illustrative embodiment 6 is the method of any preceding or subsequent illustrative embodiment, further comprising repeating at least one of steps (b)-(d) when the contaminant concentration in the wastesolution is above a threshold value.

Illustrative embodiment 7 is the method of any preceding or subsequent illustrative embodiment, further comprising discharging the wastesolution when the contaminant concentration in the wastesolution is below a threshold value.

Illustrative embodiment 8 is the method of any preceding or subsequent illustrative embodiment, wherein the contaminant concentration comprises a concentration of at least one of a polynuclear aromatic hydrocarbons, petroleum hydrocarbons, alcohols, aromatics, hydraulic fluids, solvents, detergents, synthetic oils, and/or lubricants.

Illustrative embodiment 9 is the method of any preceding or subsequent illustrative embodiment, wherein the received wastesolution is from a shipboard Exhaust Gas Cleaning system.

Illustrative embodiment 10 is the method of any preceding or subsequent illustrative embodiment, further comprising receiving bilge solution.

Illustrative embodiment 11 is the method of any preceding or subsequent illustrative embodiment, wherein the received wastesolution is from a terrestrial Exhaust Gas Cleaning system.

Illustrative embodiment 12 is the method of any preceding or subsequent illustrative embodiment, wherein the method of treating the wastesolution is continuous.

Illustrative embodiment 13 is a method of treating a wastesolution containing salt concentrations above 2%, the method comprising:

(a) receiving the wastesolution; and

(b) delivering the wastesolution to a biogenerator, wherein the biogenerator utilizes cultured hydrocarbon degrading microorganisms to reduce an amount of at least one of emulsified oil, Ammonia Nitrogen (NH₄—N), Nitrate Nitrogen (N0₃-N), Nitrite Nitrogen (N0₂-N), Total Nitrogen (TN), Chemical Oxygen Demand (COD), and/or Biological Oxygen Demand (BOD) in the wastesolution.

Illustrative embodiment 14 is the method of any preceding or subsequent illustrative embodiment, further comprising reducing an amount of free phase oil in the wastesolution.

Illustrative embodiment 15 is the method of any preceding or subsequent illustrative embodiment, wherein the amount of free phase oil is reduced by utilizing one of a hydrocyclone, a centrifuge, a gravity separator tank, and/or a coalescing plate assisted oil/water separator.

Illustrative embodiment 16 is the method of any preceding or subsequent illustrative embodiment, wherein the hydrocarbon degrading microorganisms are halotolerant.

Illustrative embodiment 17 is the method of any preceding or subsequent illustrative embodiment, wherein the hydrocarbon degrading microorganisms reduce petroleum hydrocarbon concentration and polynuclear aromatic hydrocarbon concentrations in the wastesolution.

Illustrative embodiment 18 is the method of any preceding or subsequent illustrative embodiment, further comprising measuring a contaminant concentration in the wastesolution at an outlet of the biogenerator.

Illustrative embodiment 19 is the method of any preceding or subsequent illustrative embodiment, further comprising repeating at least one of steps (b)-(c) when the contaminant concentration in the wastesolution is above a threshold value.

Illustrative embodiment 20 is the method of any preceding or subsequent illustrative embodiment, further comprising discharging the wastesolution when the contaminant concentration in the wastesolution is below a threshold value.

Illustrative embodiment 21 is the method of any preceding or subsequent illustrative embodiment, wherein the contaminant concentration comprises a concentration of at least one of a polynuclear aromatic hydrocarbons, petroleum hydrocarbons, soot, alcohols, aromatics, hydraulic fluids, solvents, detergents, synthetic oils, and/or lubricants.

Illustrative embodiment 22 is the method of any preceding or subsequent illustrative embodiment, wherein the received wastesolution is from a terrestrial Exhaust Gas Cleaning system.

Illustrative embodiment 23 is the method of any preceding or subsequent illustrative embodiment, wherein the method of treating the wastesolution is continuous.

Illustrative embodiment 24 is a wastesolution treatment system for treating a wastesolution containing salt concentrations above 2%, the system comprising:
(a) a first stage treatment system, the first stage treatment system configured to mix the wastesolution with a coagulant and a flocculant, the first stage treatment system comprising:
   (1) a coagulant storage tank;
(2) a flocculant storage tank;
(3) a mixing tank wherein a coagulant and a flocculant are mixed with the wastesolution; and
(4) a pH adjustment system;

(b) a second stage treatment system, the second stage treatment system configured to separate a concentration of solids from the wastesolution, the second stage treatment system comprising:
(1) a clarifier to separate a concentration of solids from the wastesolution, wherein the solids include particulate matter which includes at least one of soot, PM₂₅, PM₁₀, unburned fuel, partially combusted materials, arsenic, iron, vanadium, copper, rust, and/or iron oxides; and
(2) a first holding tank to collect the solids separated from the wastesolution;

(c) a third stage treatment system, the third stage treatment system configured to reduce a concentration of solids from the wastesolution, the third stage treatment system comprising:
(1) a filtration unit to further reduce the concentration of particulate matter in the wastesolution; and
(2) a pump to discharge a filtered wastesolution.

Illustrative embodiment 25 is the system of any preceding or subsequent illustrative embodiment, wherein the pH adjustment system further comprises a pH monitoring device, a first storage vessel containing an acid, a second storage vessel containing a base, and a pump system to transfer the acid and/or the base to the mixing tank.

Illustrative embodiment 26 is the system of any preceding or subsequent illustrative embodiment, further comprising a pump to transfer the coagulant from the coagulant storage tank to the mixing tank.

Illustrative embodiment 27 is the system of any preceding or subsequent illustrative embodiment, further comprising a pump to transfer the flocculant from the flocculant storage tank to the mixing tank.

Illustrative embodiment 28 is the system of any preceding or subsequent illustrative embodiment, further compromising a dewatering system to dewater the solids separated from the wastesolution in the second stage treatment system and a second holding tank for the dewatered solids.

Illustrative embodiment 29 is the system of any preceding or subsequent illustrative embodiment, wherein the filtration unit further comprises a granulated activated carbon filter, the granulated activated carbon filter utilizing granulated activated carbon to reduce a concentration of contaminants from the wastesolution.

Illustrative embodiment 30 is the system of any preceding or subsequent illustrative embodiment, wherein the filtration unit comprises at least one of a hydrocyclone, a backflushing filter, a centrifuge, a filter-cartridge, a screen-filter, and/or a disk-filter.

Illustrative embodiment 31 is the system of any preceding or subsequent illustrative embodiment, further comprising a monitor coupled to an outlet of the filtration unit configured to measure a contaminant concentration in the wastesolution at the outlet of the filtration unit.

Illustrative embodiment 32 is the system of any preceding or subsequent illustrative embodiment, further comprising a pump coupled to the outlet of the filtration unit so as to receive the filtered wastesolution and coupled to the first stage treatment system, the pump configured to recirculate the wastesolution to the first stage treatment system from the filtration unit when the monitor measures a contaminant concentration in the wastesolution above a threshold value and further configured to discharge the wastesolution from the system when the monitor measures a contaminant concentration in the wastesolution below a threshold value.

Illustrative embodiment 33 is the system of any preceding or subsequent illustrative embodiment, wherein the contaminant concentration comprises a concentration of at least one of a polynuclear aromatic hydrocarbons, soot, petroleum hydrocarbons, alcohols, aromatics, hydraulic fluids, solvents, detergents, synthetic oils, and/or lubricants.

Illustrative embodiment 34 is the system of any preceding or subsequent illustrative embodiment, wherein the first stage treatment system is configured to receive wastesolution from a shipboard Exhaust Gas Cleaning system.

Illustrative embodiment 35 is the system of any preceding or subsequent illustrative embodiment, wherein the first stage treatment system is further configured to receive bilge solution.

Illustrative embodiment 36 is the system of any preceding or subsequent illustrative embodiment, wherein the first stage treatment system is configured to receive wastesolution from a terrestrial Exhaust Gas Cleaning system.

Illustrative embodiment 37 is a wastesolution treatment system for treating a wastesolution containing salt concentrations above 2%, the system comprising a biogenerator configured to receive wastesolution and to culture hydrocarbon degrading microorganisms, wherein the hydrocarbon degrading microorganisms reduce an amount of at least one of emulsified oil, Ammonia Nitrogen (NH₄—N), Nitrate Nitrogen (N0₃-N), Nitrite Nitrogen (N0₂-N), Total Nitrogen (TN), Chemical Oxygen Demand (COD), and/or Biological Oxygen Demand (BOD) in the wastesolution, the biogenerator comprising:

(a) a wastesolution inlet for receiving wastesolution;

(b) a gas inlet for receiving gases into the biogenerator to support the growth of cultured hydrocarbon degrading microorganisms; and

(c) a nutrient inlet for receiving nutrients into the biogenerator to support the growth of cultured hydrocarbon degrading microorganisms.

Illustrative embodiment 38 is the system of any preceding or subsequent illustrative embodiment, further comprising a gas pump wherein the gas pump is a fine bubble diffuser, a slotted pipe, a compressed gas pump, and/or a dissolved air floatation pump.

Illustrative embodiment 39 is the system of any preceding or subsequent illustrative embodiment, further comprising a monitor coupled to an outlet of the biogenerator configured to measure a contaminant concentration in the wastesolution at the outlet of the biogenerator.

Illustrative embodiment 40 is the system of any preceding or subsequent illustrative embodiment, further comprising a pump coupled to the outlet of the biogenerator, the pump configured to discharge wastesolution received from the biogenerator from the wastesolution treatment system when the monitor measures the contaminant concentration level below a threshold value and further configured to recirculate the wastesolution received from the an outlet of the biogenerator to the wastesolution inlet of the biogenerator when the monitor measures the contaminant concentration level above a threshold value.

Illustrative embodiment 41 is the system of any preceding or subsequent illustrative embodiment, wherein the contaminant concentration comprises a concentration of at least one of a polynuclear aromatic hydrocarbons, soot, petroleum hydrocarbons, alcohols, aromatics, hydraulic fluids, solvents, detergents, synthetic oils, and/or lubricants.

Illustrative embodiment 42 is the system of any preceding or subsequent illustrative embodiment, further comprising a pretreatment system coupled to the wastesolution inlet of the biogenerator, the pretreatment system comprising an oil/water separator configured to reduce free phase oil in the wastesolution.

Illustrative embodiment 43 is the system of any preceding or subsequent illustrative embodiment, wherein the oil/water separator comprises at least one of a hydrocyclone, a centrifuge, a gravity separator tank, and/or a coalescing plate assisted oil/water separator.

Illustrative embodiment 44 is the system of any preceding or subsequent illustrative embodiment, wherein the biogenerator is configured to receive wastesolution from a shipboard Exhaust Gas Cleaning system.

Illustrative embodiment 45 is the system of any preceding or subsequent illustrative embodiment, wherein the biogenerator is further configured to receive bilge solution.

Illustrative embodiment 46 is the system of any preceding or subsequent illustrative embodiment, wherein the biogenerator is configured to receive wastesolution from a terrestrial Exhaust Gas Cleaning system.

Illustrative embodiment 47 is the system of any preceding or subsequent illustrative embodiment, further comprising a gas pump coupled to the gas inlet of the biogenerator so as to introduce gas into the biogenerator, the gas pump comprising at least one of a fine bubble diffuser, a slotted pipe, a compressed gas pump, and/or a dissolved air floatation pump.

Illustrative embodiment 48 is the system of any preceding or subsequent illustrative embodiment, further comprising a nutrient pump coupled to the nutrient inlet of the biogenerator so as to introduce nutrients into the biogenerator, the nutrients configured to support the growth of cultured microorganisms.

Illustrative embodiment 49 is a wastesolution treatment system for use with a terrestrial Exhaust Gas Cleaning system, the wastesolution treatment system comprising:

(a) a biogenerator configured to receive wastesolution and to culture hydrocarbon degrading microorganisms, wherein the hydrocarbon degrading microorganisms reduce an amount of at least one of emulsified oil, Ammonia Nitrogen (NH₄—N), Nitrate Nitrogen (N0₃-N), Nitrite Nitrogen (N0₂-N), Total Nitrogen (TN), Chemical Oxygen Demand (COD), and/or Biological Oxygen Demand (BOD) in the wastesolution, the biogenerator comprising:
(1) a pretreatment system coupled to a wastesolution inlet of the biogenerator, wherein the pretreatment system comprises an oil/water separator configured to reduce free phase oil in the wastesolution, the oil/water separator comprising at least one of a hydrocyclone, a centrifuge, a gravity separator tank, and/or a coalescing plate assisted oil/water separator;
(2) a wastesolution inlet for receiving wastesolution;
(3) a gas inlet for receiving gases into the biogenerator to support the growth of cultured hydrocarbon degrading microorganisms;
(4) a gas pump coupled to the gas inlet of the biogenerator so as to introduce gas into the biogenerator, the gas pump comprising at least one of a fine bubble diffuser, a slotted pipe, a compressed gas pump, and/or a dissolved air floatation pump;
(5) a nutrient inlet for receiving nutrients into the biogenerator to support the growth of cultured hydrocarbon degrading microorganisms; and
(6) a nutrient pump coupled to the nutrient inlet of the biogenerator so as to introduce nutrients into the biogenerator, wherein the nutrients configured to support the growth of cultured microorganisms;

(b) a monitor coupled to an outlet of the biogenerator configured to measure a contaminant concentration in the wastesolution at the outlet of the biogenerator, wherein the contaminant concentration comprises a concentration of at least one of a polynuclear aromatic hydrocarbons, soot, petroleum hydrocarbons, alcohols, aromatics, hydraulic fluids, solvents, detergents, synthetic oils, and/or lubricants;

(c) a pump coupled to the outlet of the biogenerator, the pump configured to discharge wastesolution received from the biogenerator from the wastesolution treatment system when the monitor measures the contaminant concentration level below a threshold value and further configured to recirculate the wastesolution received from the an outlet of the biogenerator to the wastesolution inlet of the biogenerator when the monitor measures the contaminant concentration level above a threshold value.

Illustrative embodiment 50 is a wastesolution treatment system for use with a shipboard Exhaust Gas Cleaning systems, the system comprising:
(a) a first stage treatment system, the first stage treatment system configured to mix the wastesolution with a coagulant and a flocculant, the first stage treatment system comprising:
   (1) a coagulant storage tank;
(2) a flocculant storage tank;
(3) a mixing tank wherein a coagulant and a flocculant are mixed with the wastesolution
(4) a pump to transfer the coagulant from the coagulant storage tank to the mixing tank;
(5) a pump to transfer the flocculant from the flocculant storage tank to the mixing tank; and
(6) a pH adjustment system comprising a pH monitoring device, a first storage vessel containing an acid, a second storage vessel containing a base, and a pump system to transfer the acid and/or the base to the mixing tank;

(b) a second stage treatment system, the second stage treatment system configured to separate a concentration of solids from the wastesolution, the second stage treatment system comprising:
(1) a clarifier to separate a concentration of solids from the wastesolution, wherein the solids include particulate matter which includes at least one of soot, PM_{2.5}, PM₁₀, unburned fuel, partially combusted materials, arsenic, iron, vanadium, copper, rust, and/or iron oxides; and
(2) a first holding tank to collect the solids separated from the wastesolution;
(3) a dewatering system to dewater the solids separated from the wastesolution; and
(4) a second holding tank for the dewatered solids;

(c) a third stage treatment system, the third stage treatment system configured to reduce a concentration of solids from the wastesolution, the third stage treatment system comprising:
(1) a filtration unit to further reduce the concentration of particulate matter in the wastesolution, wherein the filtration unit comprises at least one of a hydrocyclone, a backflushing filter, a centrifuge, a filter-cartridge, a screen-filter, and/or a disk-filter and the filtration unit further comprises a granulated activated carbon filter, the granulated activated carbon filter utilizing granulated activated carbon to reduce a concentration of contaminants from the wastesolution; and
(2) a pump to discharge a filtered wastesolution;

(d) a monitor coupled to an outlet of the filtration unit configured to measure a contaminant concentration in the wastesolution at the outlet of the filtration unit, wherein the contaminant concentration comprises a concentration of at least one of a polynuclear aromatic hydrocarbons, soot, petroleum hydrocarbons, alcohols, aromatics, hydraulic fluids, solvents, detergents, synthetic oils, and/or lubricants; and

(e) a pump coupled to the outlet of the filtration unit so as to receive the filtered wastesolution and coupled to the first stage treatment system, the pump configured to recirculate the wastesolution to the first stage treatment system from the filtration unit when the monitor measures a contaminant concentration in the wastesolution above a threshold value and further configured to discharge the wastesolution from the system when the monitor measures a contaminant concentration in the wastesolution below a threshold value

The terms “comprising,” “having,” “including,” and “containing” are to be construed as open-ended terms (i.e., meaning “including, but not limited to”) unless otherwise noted. The term connected is to be construed as partly or wholly contained within, attached to, or joined together, even if there is something intervening. Recitation of ranges of values herein are merely intended to serve as a shorthand method of referring individually to each separate value falling within the range, unless otherwise indicated herein, and each separate value is incorporated into the specification as if it were individual recited herein. All methods described herein can be performed in any suitable order unless otherwise indicated or clearly contradicted by context. The use of any and all examples or exemplary language is intended merely to better illuminate embodiments of the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventor for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated or otherwise clearly contradicted by context.

What is claimed is:

1. A method of treating a wastesolution containing salt concentrations above 2%, the method comprising:
(a) receiving the wastesolution;
(b) mixing the wastesolution with a coagulant and a flocculant; and
(c) separating a concentration of solids from the wastesolution using a clarifier, wherein the solids include particulate matter which includes at least one of soot, PM_{2.5}, PM₁₀, unburned fuel, partially combusted materials, arsenic, iron, vanadium, copper, rust, and/or iron oxides; and
(d) delivering a supernatant of the wastesolution from the clarifier to a filtration unit to further reduce the concentration of particulate matter in the wastesolution.

2. The method of claim 1, wherein the filtration unit is a granulated activated carbon filter, the granulated activated carbon filter utilizing granulated activated carbon to reduce a concentration of contaminants from the wastesolution.

3. The method of claim 1, wherein the filtration unit reduces the concentration of particulate matter in the wastesolution by utilizing at least one of a hydrocyclone, a backflushing filter, a centrifuge, a filter-cartridge, a screen-filter, and/or a disk-filter.

4. The method of claim 1, further comprising measuring a contaminant concentration in the wastesolution at an outlet of the filtration unit.

5. The method of claim 4, further comprising repeating at least one of steps (b)-(d) when the contaminant concentration in the wastesolution is above a threshold value.

6. The method of claim 4, further comprising discharging the wastesolution when the contaminant concentration in the wastesolution is below a threshold value.

7. The method of claim 4, wherein the contaminant concentration comprises a concentration of at least one of a polynuclear aromatic hydrocarbons, petroleum hydrocarbons, alcohols, aromatics, hydraulic fluids, solvents, detergents, synthetic oils, and/or lubricants.

8. A method of treating a wastesolution containing salt concentrations above 2%, the method comprising:
(a) receiving the wastesolution; and
(b) delivering the wastesolution to a biogenerator, wherein the biogenerator utilizes cultured hydrocarbon degrading microorganisms to reduce an amount of at least one of emulsified oil, Ammonia Nitrogen (NH₄—N), Nitrate Nitrogen (N0₃-N), Nitrite Nitrogen (N0₂-N), Total Nitrogen (TN), Chemical Oxygen Demand (COD), and/or Biological Oxygen Demand (BOD) in the wastesolution.

9. The method of claim 8, further comprising reducing an amount of free phase oil in the wastesolution.

10. The method of claim 9, wherein the amount of free phase oil is reduced by utilizing one of a hydrocyclone, a centrifuge, a gravity separator tank, and/or a coalescing plate assisted oil/water separator.

11. The method of claim 8, wherein the hydrocarbon degrading microorganisms are halotolerant.

12. The method of claim 8, wherein the hydrocarbon degrading microorganisms reduce petroleum hydrocarbon concentration and polynuclear aromatic hydrocarbon concentrations in the wastesolution.

13. The method of claim 8, further comprising measuring a contaminant concentration in the wastesolution at an outlet of the biogenerator.

14. The method of claim 13, further comprising discharging the wastesolution when the contaminant concentration in the wastesolution is below a threshold value.

15. The method of claim 8, wherein the contaminant concentration comprises a concentration of at least one of a polynuclear aromatic hydrocarbons, petroleum hydrocarbons, soot, alcohols, aromatics, hydraulic fluids, solvents, detergents, synthetic oils, and/or lubricants.

16. A wastesolution treatment system for treating a wastesolution containing salt concentrations above 2%, the system comprising:
(a) a first stage treatment system, the first stage treatment system configured to mix the wastesolution with a coagulant and a flocculant, the first stage treatment system comprising:
(1) a coagulant storage tank;
(2) a flocculant storage tank;
(3) a mixing tank wherein a coagulant and a flocculant are mixed with the wastesolution; and
(4) a pH adjustment system;
(b) a second stage treatment system, the second stage treatment system configured to separate a concentration of solids from the wastesolution, the second stage treatment system comprising:
(1) a clarifier to separate a concentration of solids from the wastesolution, wherein the solids include particulate matter which includes at least one of soot, PM_{2.5}, PM₁₀, unburned fuel, partially combusted materials, arsenic, iron, vanadium, copper, rust, and/or iron oxides; and
(2) a first holding tank to collect the solids separated from the wastesolution;
(c) a third stage treatment system, the third stage treatment system configured to reduce a concentration of solids from the wastesolution, the third stage treatment system comprising:
(1) a filtration unit to further reduce the concentration of particulate matter in the wastesolution; and
(2) a pump to discharge a filtered wastesolution.

17. The system of claim 16, wherein the pH adjustment system further comprises a pH monitoring device, a first storage vessel containing an acid, a second storage vessel containing a base, and a pump system to transfer the acid and/or the base to the mixing tank.

18. The system of claim 16, further compromising a dewatering system to dewater the solids separated from the wastesolution in the second stage treatment system and a second holding tank for the dewatered solids.

19. The system of claim 16, further comprising a monitor coupled to an outlet of the filtration unit configured to measure a contaminant concentration in the wastesolution at the outlet of the filtration unit.

20. The system of claim 19, further comprising a pump coupled to the outlet of the filtration unit so as to receive the filtered wastesolution and coupled to the first stage treatment system, the pump configured to recirculate the wastesolution to the first stage treatment system from the filtration unit when the monitor measures a contaminant concentration in the wastesolution above a threshold value and further configured to discharge the wastesolution from the system when the monitor measures a contaminant concentration in the wastesolution below a threshold value.
